(19) United States
(12) Patent Application Publication
(10) Pub. No.: US 2009/0263043 A1
(43) Pub. Date: Oct. 22, 2009

(54) BLIND DECONVOLUTION AND SUPER-RESOLUTION METHOD FOR SEQUENCES AND SETS OF IMAGES AND APPLICATIONS THEREOF

(75) Inventors: Gabriel Cristobal Perez, Madrid (ES); Filip Sroubek, Madrid (ES)

Correspondence Address: DARBY & DARBY P.C., P.O. BOX 770, Church Street Station, New York, NY, 10008-0770, US

(73) Assignee: CONSEJO SUPERIOR DE INVESTIGACIONES CIENTIFICAS, Madrid (ES)

(21) Appl. No.: 12/090,192

(22) PCT Filed: Oct. 10, 2006
(86) PCT No.: PCT/ES06/70150

§ 371 Date: Jul. 16, 2008

(30) Foreign Application Priority Data
Oct. 14, 2005 (ES) P200502510

(51) Int. Cl. G06K 9/40

(52) U.S. Cl. 382/275

(57) ABSTRACT

The present invention relates to the image achieved by any conventional method of capture and their subsequent computer processing. The process of the invention presented is based on the simultaneous processing of the input images and their restoration (deconvolution) pixel by pixel by means of a new mathematical method. Furthermore, and in the case of having more than one image of the scene in question, the system is capable of providing superresolution of the input images. It has direct application in digital photographic cameras, digital video cameras, mobile phones, video and photography edition programmes, image analysis programmes for microscopy and astronomy, analysis of medical images, forensic image, image-based security systems, aerial image and in the restoration of works of art, among others.

This application is a U.S. national phase application under 35 U.S.C. §371 of International Patent Application No. PCT/ES2006/070150 filed October 10, 2006, which claims the benefit of priority to Spanish Patent Application No. P200502510 filed Oct. 14, 2005, the disclosures of all of which are hereby incorporated by reference in their entireties. The International Application was published in Spanish on Apr. 19, 2007 as WO 2007/042596.

### FIELD OF THE INVENTION

In general terms, the present invention relates to the processing of images, achieved by any conventional method of capture, blurred or of low resolution. It has direct application in digital photographic cameras, digital video cameras, mobile phones, video and photography edition programmes, image analysis programmes for microscopy and astronomy, analysis of medical images, forensic image, image-based security systems, aerial image and in the restoration of works of art, among others.

### BACKGROUND

Within the scope of image processing, superresolution (SR) is understood as those techniques which provide an improvement in the resolution of the images captured or acquired by the system. There are several points of view so that a certain technique can be considered to provide SR. Some authors consider as SR all those methods which exceed the diffraction limits of the systems, whilst others consider SR to be those techniques which go beyond the limits of the digital image sensor. There are also variants of SR which use a single-frame of the image or multiple-frames, this last case, however, being of greatest interest. In the majority of SR algorithms, the information which is gained in the SR image is present in the low-resolution images in the form of “aliasing” or spectral dispersion. It is for this reason that a requirement so that the SR can be obtained is that the sensor has limited features so that the “aliasing” may be present. On the other hand, the term deconvolution (image restoration) in optics refers to a process of inverting the optical distortion obtainable with any optical instrument, e.g. camera, microscope, telescope, etc. with the object of obtaining sharper images. Deconvolution techniques are also useful for improving images which have suffered distortion due to rapid movement during the capture.

The methods of superresolution, used in some image-processing computer programmes, consider that the misalignment between them is unknown when the scale of the subpixel is considered (the most used due to the quality of the end results), but, however, all of them assume that the function of point spread function (PSF) of the channels (low-resolution observations or LR,), is known to us a priori. The PSF is the mathematical function which describes the distortion suffered by a theoretical point of light on passing through the measuring instrument or sensor in question. A complete bibliographic review on the matter can be consulted in [Nguyen 05].

Until now, the practical methods used in the art to resolve the aforementioned problems in image processing are: a) Maximum Likelihood, ML), b) Maximum a Posteriori (MAP), c) Projection onto convex sets (POCS), and, finally, d) Fast Fourier Transform based techniques (FFT). All of them provide a reasonable solution to the problem of obtaining the superresolution image. Recently, new, more advanced techniques have been proposed [Segall 03, Hardie 97] which permit carrying out an appropriate estimate of the subpixel slip and, therefore, of the SR image. However, it still does not concern, strictly speaking, blind methods, i.e. methods in which the blur is either previously known or is considered not to exist. Recently, several researchers [Nguyen 05, Woods 03] proposed a blind SR method which uses PSF but which may be modelled on a single parameter (with the time savings that this simplification entails). However, this last restriction greatly limits the practical applicability of this type of method with the subsequent decrease in resolution (quality) of the final image. With the aim of resolving this situation, a complete blind SR method has recently been proposed [Wirawan 99, Yagle 03], but, however, in its formulation, there is an inherent irresolution in the way in which the high-resolution image is obtained, with the disadvantage of being very sensitive to noise. Other preliminary results leading to the resolution of the problem of blind estimation of the superresolution image have been proposed in [Biggs 04] by a modification of the Richardson-Lucy method.

With regard to the known commercial products, Adobe Photoshop and Philips have some superresolution systems. Nevertheless and as previously mentioned, they do not provide similar features to those permitted by the the present invention . The manufacturers of mobile phones or digital cameras may be potential recipients. This would involve that in order to obtain high-quality images it would not be necessary to have high-definition sensors. There is no commercial product which allows performing deconvolution (image restoration) and superresolution simultaneously. Some of the patents related to the present invention are referenced below. Reference [Callico 05] describes the current state of the art in terms of the process of implementation of the superresolution methods in real time, a work recently presented in the congress of the SPIE (The International Society for Optical Engineering) by members of the [(Instituto Universitario of Microelectrónica Aplicada (University Institute of Applied Microelectronics)] of the University of Las Palmas (IUMA)

### SUMMARY OF THE INVENTION

The present invention relates to a process of simultaneous processing of blurred or out of focus images, achieved by any traditional process, and its restoration pixel by pixel by means of a mathematical blind deconvolution algorithm. Furthermore, and in the case of having more than one image of the scene captured, the method is capable of providing superresolution of the input images.

### DETAILED DESCRIPTION

The processing of images plays a fundamental role in many applications such as astronomy, remote perception, microscopy or tomography, among others. Due to the imperfections of the capture devices (optical degradations, limited size of the CCD sensors, etc.) as well as the instability of the scene observed (moving objects, atmospheric turbulence, etc.), the images acquired may appear blurred, noisy and they may even have insufficient spatial and time resolution.

The present invention tackles the problem of providing new processes for processing and reconstructing images.

The invention is based on the fact that the inventors are capable of recovering the original image by the simultaneous techniques of blind deconvolution and superresolution which permit eliminating the blur and increasing the resolution, respectively. A necessary condition so that the methods are stable is having more than one image of the scene in question (sets of images). The differences between the images of a set are necessary in order to provide new information, which otherwise would be imperceptible [(for example, by means of small slips or slight modifications in the acquisition parameters (focal length, aperture size, etc.)].

The current techniques of blind deconvolution of sets of images do not require (or at most, require little) prior information on the blur and are sufficiently robust to noise to provide satisfactory results in most applications. However, the methods process low resolution images with difficulty. In contrast, the current superresolution techniques provide satisfactory results in the improvement of resolution by means of the estimation of subpixel slip between images, but are incapable of calculating the blur. The current methods of superresolution suppose the non-existence of blur or that it may be estimated by other means. The present invention provides a unified method of reconstruction of an image which simultaneously provides an estimate of the blur present in the images, without any a priori knowledge thereof or the existence of the original image. This problem is resolved by means of the blind estimation of the original image, by means of an SR process based on variational calculation methods by means of the minimization of an energy functional together with appropriate terms of regularization. The grounds of this type of method relate to incorporating in the energy functional all the knowledge available on the problem. A functional is a function that can take other functions as an argument, such as, for example, integrals of an unknown function and their derivatives. It is of great interest to use the so-called “extreme” functions as arguments, i.e. functions which make the functional reach a maximum or a minimum. By means of the minimization, a robust method is obtained which permits simultaneously estimating the PSF, the subpixel misalignment and the high resolution image. This guarantees an almost perfect solution to the problem (in the case of absence of noise). The method can be extended to the 3D case, not only in the case of volumes (confocal microscopy, electronic tomography), but also in the case of image sequences (video) where the third dimension is time, as well as in the case of colour images.

It is important to indicate in this point that none of the systems known at this time is capable of providing the aforementioned simultaneous information, for which reason this invention constitutes a significant advance in the area of image processing.

FIG. 1 presents a general operating diagram of the present invention. The upper part presents the multiple image acquisition system, whilst the lower part presents the reconstruction of the high resolution image from the real world. It can be observed that the quality of the reconstructed image is practically identical to the image from the real world. Below, the general expression which governs the functioning of the method in order to be able to fix the notation used in the rest of the document, is presented:

D[u*gₖ] (τₖ (x, y))+nₖ (x, y)=zₖ (x, y) (1)

In Equation 1, zₖ are the images acquired by the sensor or the sensors and therefore represent the unique input data to the system due to the blind character of the method in question. The original image (to be obtained) without degradations or with greater resolution is represented by u. The blur functions gₖ intervene in the process by means of a convolution operation represented by the symbol *, whilst D represents a decimated operator which is what reports the superresolution process. The noise present in the system is represented by nₖ. The objective which is pursued is to perform the estimate of u only from the information provided by the input images zₖ. The problem is resolved by means of the minimization of an energy functional E, which depends on the original image u and blur functions hᵢ, wherein the hᵢ are derived from the gₖ by no more than including the slips of tₖ in gₖ. For this, it is considered that the input images may present small slips, i.e. that the hypothesis established is that the PSF functions of the blur may show slips. This fact provides a greater degree of robustness to the system due to the fact that this is tolerant to small changes in the recording (alignment) of the images, in addition to providing the additional information necessary to obtain the superresolution. The expression of energy E(u,hk) stated in FIG. 1 is given by,

$$E ( u , \{ {h}_{k} \} ) = {\sum }_{k = 1}^{K} {‖ D [ u * {h}_{k} ] - {z}_{k} ‖}^{2} + λ Q ( u ) + γ R ( \{ {h}_{k} \} ) \qquad ( 2 )$$

wherein the first term of the right of equation 2 has an obvious interpretation since it represents the minimization of the quadratic error between the original image and the images acquired, whilst the other two terms represent regularization functions of the original image and the blur, respectively, and which are necessary to consider in order that the solution is more stable. For the first of them Q, i.e. the term of regularization of the original image, several solutions have been proposed. They are all based on the minimization of a functional derived from the gradient of the image, such as, for example, the Tichonov regularization, anisotropic regularization or the Mumford-Shah regularization (see reference [Sroubek 03]).

In the examples which illustrate the present invention, the total variation method (Total Variation) has been used for Q [Sroubek 03]. Once the problem has been formulated in the aforementioned form, the final solution is determined by means of a process of successive minimization in accordance with u and hi of the functional energy given by Equation 2. With regard to the second term of regularization R of the blur, this is based on the differences between each pair of blurred input images, by means of a mathematical expression which approximates zero for the correct values of the blur. Therefore, an object of the present invention constitutes a method of processing of a low resolution and/or blurred image, hereinafter method of the invention, which permits the simultaneous estimate of the point spread function and the subpixel misalignment and the high resolution image and which comprises the following stages:
i) obtainment of several images of the problem image by acquisition techniques or sensors of conventional images,
ii) simultaneous or unified reconstruction of the images of a) by a technique or method of deconvolution or multiframe blind estimate of the original image and a superresolution method based on a variational calculation method by means of the minimization a function of energy (E) by a process of restricted squared minimums together with appropriate terms of regularization of the original image and the blur, where the general expression which governs the functioning of the method is,

D[u*gₖ] (τₖ (x, y))+nₖ (x, y)=zₖ (x, y)

such that, zₖ are the images acquired by the sensor or the sensors; the original image (to be obtained) without degradations or with higher resolution represented by u; The blur functions gₖ intervene in the process by means of a convolution process represented by the symbol *, whilst D represents a decimated operator (fractional dyadic) which is what reports the superresolution process; and, the noise present in the system is represented by nₖ, and where, the expression of energy E(u,hk) is given by,

$$E ( u , \{ {h}_{k} \} ) = {\sum }_{k = 1}^{K} {‖ D [ u * {h}_{k} ] - {z}_{k} ‖}^{2} + λ Q ( u ) + γ R ( \{ {h}_{k} \} )$$

and,
iii) Obtainment of the high resolution image of the original image.

A particular object of the invention constitutes the method of the invention wherein the function of regularization of the original image (Q) is carried out by minimization of a functional derived from the gradient of the image belonging, by way of illustration and without limiting the invention, to the following group: the Tichonov regularization, anisotropic regularization or the Mumford-Shah regularization or the total variation method (Total Variation) [Sroubek 03].

A particular embodiment of the present invention relates to a method of the invention wherein the function of regularization of the original image (Q) is carried out by the total variation method (Total Variation) (see Example 1 and 2).

Another object of the present invention relates to the use, hereinafter use of the method of the invention, of the method of the invention for the reconstruction or recovery of images.

A particular object of the invention relates to the use of the method of the invention wherein the image is two-dimensional or three-dimensional, and in the case of the latter not only for the case of volumes (confocal microscopy, electronic tomography), but also in the case of image sequences (video) where the third dimension is time. Likewise, these images may be in black or white, range of any colour or in colour.

The images on which the method of the invention may be applied may be of different origin, for example, by way of illustration and without limiting the scope of the invention: images from digital photographic cameras, digital video cameras, mobile phones, video and photography edition programmes, image analysis programmes for microscopy—among others, confocal microscopy or electronic tomography—and of astronomy, analysis of medical images, forensic images, image-based security systems, aerial images or works of art as a frame subject to restoration.

### BIBLIOGRAPHIC REFERENCES

[Biggs 04] D. S. Biggs, C. L. Wang, T. J. Holmes, and A. Khodjakov, “Subpixel deconvolution of 3D optical microscope imagery,” in Proc. SPIE Vol. 5559, pp. 369-380, Oct. 2004.
[Callico 05]G. Callicó et al., “Practical Considerations for real-time 30 superresolution implementation techniques over video coding platforms”, SPIE Microtechnologies for the New Millenium, Seville, May, 2005.
[Hardie 97] R. C. Hardie, K. J. Barnard, and E. E. Armstrong, “Joint MAP registration and high-resolution image estimation using a sequence of undersampled images,” IEEE Trans. Image Processing., vol. 6, pp. 1621-1633, Dec.1997.
[Nguyen 05] N. Nguyen, P. Milanfar, and G. Golub, “Efficient generalized cross-validation with applications to parametric image restoration and resolution enhancement,” IEEE Transactions on Image Processing, vol. 10, no. 9 , pp. 1299-1308, Sep. 2001.
[Park 03] S. C. Park, M. K. Park, and M. G. Kang, “Superresolution image reconstruction: A technical overview,” IEEE Signal Processing Magazine, vol. 20, pp. 21-36, 2003.
[Segall 03] C. A. Segall, R. Molina, and A. K. Katsaggelos, “High-resolution image from low-resolution compressed video,” IEEE Signal Processing Magazine, vol. 20, pp. 37-48, 2003.
[Sroubek 03] Sroubek, F. and Flusser, J. “Multichannel Blind Iterative Image Restoration,” IEEE Transactions on Image Processing, 12,9, pp. 1094-1106, 2003
[Wirawan 99] Wirawan, P. Duhamel, and H. Maitre, “Multichannel high resolution blind image restoration,” in Proc. IEEE ICASSP, AZ, pp. 3229-3232, Nov. 1999.
[Woods 03] N. A. Woods, N. P. Galatsanos, and A. K. Katsaggelos, “EM-Based Simultaneous Registration, Restoration, and Interpolation of Superresolved Images,” in Proc. IEEE ICIP, pp.303-306, Sep. 2003.
[Yagle 03] A. E. Yagle, “Blind superresolution from undersampled blurred measurements,” in Proc. SPIE Vol. 5205, pp. 299-309, Dec. 2003.

Other patents related to the present invention:
[Messing 02] Messing, D. and Sezan, M. I. “Resolution improvement for multiple images”, U.S. Pat. No. 6,466,618, 2002.
[Gregory 02] Gregory, D. D. et al “Super Resolution methods for electrooptical systems”, U.S. Pat. No. 6,483,952, 2002 [Burt 02] Burt, P. et al “Mosaic based image processing system”, U.S. Pat. No. 6,393,163, 2002.
[Patti 01] Patti, A. J. et al “Method for generated Resolution enhanced still images from compressed video data”, U.S. Pat. No. 6,304,682, 2001.

### DESCRIPTION OF THE FIGURES

FIG. 1. General diagram of the image acquisition and processing system of the invention. The upper part shows the acquisition system of multiple images and the lower part shows the reconstruction of a real scene.

FIG. 2. Reconstruction of an original image with the observer in movement. (a) Set of low resolution images which constitute the data input to the system; (b) Result of the linear interpolation of the first frame of the sequence considered; (c) Result of the linear interpolation of a low resolution frame (LR) using a tripod to avoid the blur due to movement; (d) Result of the linear interpolation after applying the multi-frame blind deconvolution process; (e) Image captured with tripod using optical zoom. This image may be considered as reference when evaluating the result of the reconstructed high resolution image; (f) The resulting image which combines the application of a multi-frame blind deconvolution process together with a superresolution process. It can be observed that the result (f) constitutes a very good approximation to (e), whilst (d) provides an unsatisfactory result.

FIG. 3. Reconstruction of an image with the original in movement. (a) Set of low resolution images which constitute the data input to the system; (b) Result of the linear interpolation of the first frame of the sequence considered; (c) Result of the linear interpolation after applying the multi-frame blind deconvolution process; (d) Result provided by the best current superresolution technique. This figure shows that this method is incapable of eliminating the blur present in the input images; (e) Result of the method of the present invention which combines the application of a multi-frame blind deconvolution process together with a superresolution process; (f) Blur functions which provide the method of the invention.

### EXAMPLE OF THE EMBODIMENT OF THE INVENTION

Two examples of practical use of the technique developed have been presented, by way of illustration and without this representing a limitation to the scope of the invention.

### Example 1

### Reconstruction of a Blurred Image Due to Movement of the Observer

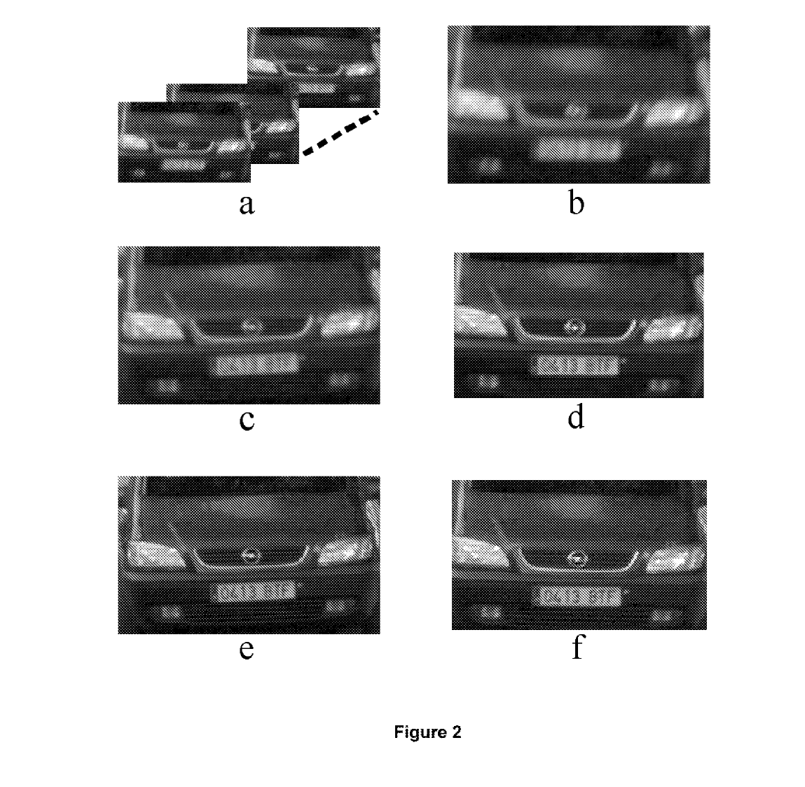

The first scenario consists of the detection of license plates, wherein the blur presented by the images is due to the capture conditions due to the movement introduced by the observer on holding the camera (FIG. 2).

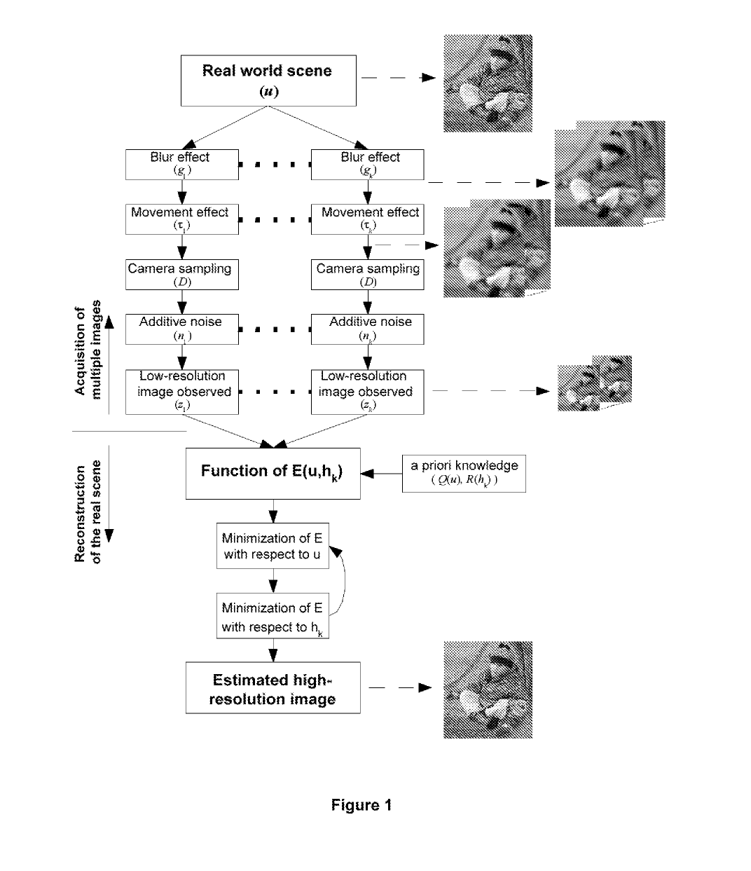

Likewise, the low lighting conditions or the far distance of the object of interest produces low quality input images (FIG. 1a) which hinders both the identification of the alphanumerical characteristics of the license plate and the characteristics which identify the vehicle, such as make, form of the chassis, etc.

The image obtained by the method of the invention (FIG. 2f) is better even than those obtained by an optical zoom with tripod (FIG. 2e) which are considered of reference, and clearly better than those obtained by other known methods (FIG. 1b, c and d). Details of the image capture process: Olympus Digital camera, 5 Mpixels model C-5050. Aperture: 8.0; Shutter speed: 1/20 sec.; Focal length: 11.9 mm (for the low resolution images). For the high resolution images, the same previous parameters, except the focal length: 21.3 mm.

### Example 2

### Reconstruction of a Blurred Image Due to Movement of the Object

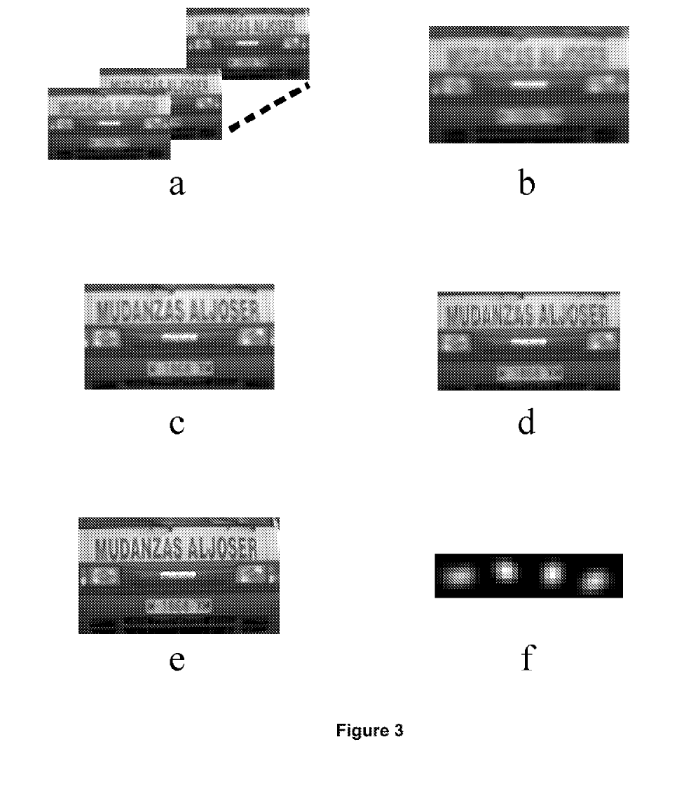

The second scenario consists of the capture of low-resolution images of a vehicle which moves forward to the camera (FIG. 3). It is observed that the method of the invention is capable of carrying out a compensation due to the movement and obtaining a high-resolution image (FIG. 3e) as output with greater resolution than those obtained by the other techniques (FIG. 3b, c and d), better even than with the best current superresolution technique [Hardie 97], which is incapable of eliminating the blur present in the input images (FIG. 3d). The result of FIG. 3d has been obtained from an implementation of the method described in [Hardie 97] to which an improvement has been incorporated consisting of preserving the edges of the image.

This would be a case complementary to the previous one, wherein the camera is fixed and the object in movement. Details of the image capture process: Olympus Digital camera, 5 Mpixels model C-5050. Aperture: 8.0; Shutter speed: 1/30 sec.; Focal length: 21.3 mm.

1. A method of processing a low resolution and/or blurred image characterized in that it permits the simultaneous estimation of the point spread function and the high-resolution image, comprising:
i) obtaining several images of the problem image by acquisition techniques or sensors of conventional images,
ii) performing simultaneous or unified reconstruction of the images by a method of deconvolution or multiframe blind estimate of the original image and a superresolution method based on a variational calculation method by means of the minimization a function of energy (E) by a process of restricted squared minimums together with terms of regularization of the original image and the blur, wherein the general expression which governs the functioning of the method is,
D[u*gₖ] (τₖ (x, y))+nₖ (x, y)=zₖ (x, y)
such that, zₖ are the images acquired by the sensor or the sensors; the original image without degradations or with higher resolution is represented by u; the blur functions gₖ intervene in the process by means of a convolution process represented by the symbol *, wherein D represents a decimated operator; the noise present in the system is represented by nₖ, and wherein, the expression of energy E(u,hk) is given by,
$$E ( u , \{ {h}_{k} \} ) = {\sum }_{k = 1}^{K} {‖ D [ u * {h}_{k} ] - {z}_{k} ‖}^{2} + λ Q ( u ) + γ R ( \{ {h}_{k} \} )$$
and,
iii) Obtainment of obtaining the high resolution image of the original image.

2. The method according to the claim 1, wherein regularization of the original image (Q) of ii) comprises minimizing a function derived from the gradient of the image, wherein the function is selected from the group consisting of Tichonov regularization, anisotropic regularization, and Mumford-Shah regularization.

3. The method according to the claim 1, wherein the function of regularization of the original image (Q) of ii) is carried out by the total variation method.

4. (canceled)

5. The method of claim 1, wherein the image is two-dimensional or three-dimensional.

6. The method of claim 1, wherein the image is in black and white, in a range of any color, or in color.

7. The method of claim 1, wherein the image may be of different origin.

8. The method of claim 7, wherein the origin of the image is selected from the group consisting of: digital photographic cameras, digital video cameras, mobile phones, video edition programs, photography edition programs, image analysis programs, confocal microscopy, electronic tomography, astronomy, medical images, forensic images, image-based security systems, aerial images, and works of art as frame.
